(19) United States
(12) Patent Application Publication
(10) Pub. No.: US 2021/0124821 A1
(43) Pub. Date: Apr. 29, 2021

(54) Operating System Implementation of Language to Describe Permissions

(71) Applicant: Facebook Technologies, LLC, Menlo Park, CA (US)

(72) Inventors: Vadim Victor Spivak, Redwood City, CA (US); Stanislav Sedov, San Jose, CA (US)

(21) Appl. No.: 16/667,800

(22) Filed: Oct. 29, 2019

(51) Int. Cl. G06F 21/52

(52) U.S. Cl. CPC G06F 21/52; G06F 2221/2141; G06F 2221/033

(57) ABSTRACT

In one embodiment, an access control method includes receiving, from an application, a permission rule defining a criterion for permitting the application to access a resource, where the criterion identifies a logic predefined by the operating system and a condition for satisfying the logic. The method includes storing the permission rule and associating the stored permission rule with the application. The method includes receiving, from the application, a request to access the resource. The method includes accessing the stored permission rule associated with the application. The method includes determining that the application is permitted to access the resource by processing the logic and the condition. The method includes allowing the application to access the resource.

### TECHNICAL FIELD

This disclosure generally relates to permissions used in an operating system.

### BACKGROUND

In computer programming, a permission may refer to access rights for specific users and groups of users. Permissions may be assigned to applications as well. Conventional operating systems may provide a static list of resource permissions to applications. These current operating systems may be designed to enforce blanket permissions, such as whether an application has access to a camera. After an application is given the blanket permission to access the camera, the application has permission to access the camera whenever.

### SUMMARY OF PARTICULAR EMBODIMENTS

Disclosed herein are a variety of different ways of generating permissions for applications to access resources and enable capabilities. In particular embodiments, the use of these permissions may be specific for applications in an operating system for an augmented reality or virtual reality environment. The use of an augmented reality system or virtual reality system may be different than a typical computing system. As such, there may be privacy and security concerns that are unique to an augmented reality system or virtual reality system. As an example and not by way of limitation, within an augmented reality operating system environment, an application should not be given total access to the device's camera. This may be because there are certain situations where a user may want to restrict camera access, such as within a bathroom. One goal of the disclosed methods may be to implement a more flexible permission scheme, where permissions incorporate contexts described by dynamic variables. Conventional operating systems may provide a static list of resource permissions to applications (e.g., can_access_camera). The current operating systems may be designed to enforce blanket permissions. This permission scheme may be restrictive because it can be inflexible, and it may not be based on dynamic information (e.g., the current location), and not sufficiently granular (e.g., grant/deny access to specific ports or websites). In addition, this permission scheme may not suitable for certain augmented reality applications (e.g., grant camera access in certain places but turn off camera access in others) because these blanket permission may not be sufficient for all usage contexts. These blanket permission may not be sufficient because it may be undesirable for an application to be granted permission to access the camera at all times.

In particular embodiments, when an application is initially installed, it may ask the user to grant context-based permissions. As an example and not by way of limitation, the application may ask the user for permission to access the device's camera in particular contexts (e.g., when the user is outdoors). In particular embodiments, the granted permission may then be stored in a permission broker, which is running as a service. When the application wants to access the camera, the application may send a request to access the camera. Then the camera's service would identify the app and may ask the permission broker for the list of permissions that has been granted to the application. The camera's service may then check whether the conditions attached to the permissions are satisfied by the current context (e.g., the camera service may query other services for the current GPS location, Live-Maps location, time, etc.). If the contextual conditionals are satisfied, the application may be given access to the camera. If the contextual conditionals are not satisfied, the application may generate a notification requesting updated permissions. This may be in the instance for one-time use cases or needing to expand out the granted permission.

In particular embodiments, to implement context-based permissions, declarative language may be used to define an operating system's support/enforce permissions. In this configuration, applications may specify their permission requirements with finer granularity and based on dynamic information. As an example and not by way of limitation, an application may only have access to a particular web address and nothing else based on a current location. In particular embodiments, when an application requests for resources, the permission broker will check whether the permission rule defined by the application is satisfied. If so, the permission broker may request the microkernel to issue a token (capability-based privilege; e.g., a particular process has privilege to certain capabilities) and pass that token to the application. When the application requests for resource access, the kernel may check whether the token is valid before granting access. The implementation of the context-based permissions may allow for more flexibility in setting conditions for permissions. The context-based permissions may improve the security and privacy of a user through restricting application permissions based on certain contexts.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example operating system environment associated with a virtual reality system.

FIG. 2 illustrates an example permission request.

FIG. 3 illustrates an example list of permission settings.

FIG. 4 illustrates an example diagram flow of handling a hardware access request.

FIGS. 5A-5B illustrate example diagram flows of requesting hardware access within an operating system environment.

FIG. 6 illustrates an example network environment associated with a virtual reality system.

FIG. 7 illustrates an example method for handling a permission rule associated with an application.

FIG. 8 illustrates an example method for handling a hardware access request from an application.

FIG. 9 illustrates an example computer system.

### DESCRIPTION OF EXAMPLE EMBODIMENTS

Conventional operating systems may provide a static list of resource permissions to applications (e.g., can_access_camera). The current operating systems may be designed to enforce blanket permissions. This permission scheme may be restrictive because it can be inflexible, and it may not be based on dynamic information (e.g., the current location), and not sufficiently granular (e.g., grant/deny access to specific ports or websites). In addition, this permission scheme may not suitable for certain augmented reality applications (e.g., grant camera access in certain places but turn off camera access in others) because these blanket permission may not be sufficient for all usage contexts. These blanket permission may not be sufficient because it may be undesirable for an application to be granted permission to access the camera at all times. It may be more desirable for the camera permission to be conditionally granted based on the user's context, such as when the user is outdoors and not when the user is at home.

In particular embodiments, in order to implement dynamic information for permissions, the operating system may enforce context-based permissions. When an application is initially installed, it may ask the user to grant context-based permissions. As an example and not by way of limitation, the application may ask the user for permission to access the device's camera in particular contexts (e.g., when the user is outdoors). In particular embodiments, the granted permission may then be stored in a permission broker, which is running as a service. When the application wants to access the camera, the application may send a request to access the camera. Then the camera's service would identify the app and may ask the permission broker for the list of permissions that has been granted to the application. The camera's service may then check whether the conditions attached to the permissions are satisfied by the current context (e.g., the camera service may query other services for the current GPS location, Live-Maps location, time, etc.). If the contextual conditionals are satisfied, the application may be given access to the camera. If the contextual conditionals are not satisfied, the application may generate a notification requesting updated permissions. This may be in the instance for one-time use cases or needing to expand out the granted permission.

In particular embodiments, these contexts may include a location-based context, a time-based context, and an activity-based context. As an example and not by way of limitation, location-based contexts may include “at home”, “at work”, “only here”, “only this room”, and the like. There may be opposite location-based contexts, such as “anywhere but here” for instance to avoid giving permissions to an application when a user is in their bedroom. As an example and not by way of limitation, time-based contexts may include “during the day”, “at night”, “for a specified time period”, and the like. As an example and not by way of limitation, activity-based contexts may include “while driving”, “while working out”, and the like. This may help restrict permissions to applications for certain contexts, such as a maps application to only receive GPS location when the user is driving. In particular embodiments, opposite contexts may be implemented in a location-based context, a time-based context, and an activity-based context. Applications may also request context-based permissions when needing to perform an action. As an example and not by way of limitation, while an application may need permission to access a camera (e.g., to generate an AR element on a wall, such as a painting), the application may not necessarily need persistent permission to access the camera. Therefore, applications may request one-time context-based permissions as necessary through notifications displayed to the user, which need to be accepted by the user. There can be multiple combinations of the various contexts to generate the context-based permissions. As an example and not by way of limitation, permission to access a camera may require the user to be outside of home and the time be during the day. Once the contextual conditionals are satisfied, the application may be given access to the camera.

In particular embodiments, to implement context-based permissions, declarative language may be used to define an operating system's support/enforce permissions. In this configuration, applications may specify their permission requirements with finer granularity and based on dynamic information. As an example and not by way of limitation, an application may only have access to a particular web address and nothing else based on a current location. In particular embodiments, when an application requests for resources, the permission broker will check whether the permission rule defined by the application is satisfied. If so, the permission broker may request the microkernel to issue a token (capability-based privilege; e.g., a particular process has privilege to certain capabilities) and pass that token to the application. When the application requests for resource access, the kernel may check whether the token is valid before granting access. The implementation of the context-based permissions may allow for more flexibility in setting conditions for permissions. The context-based permissions may improve the security and privacy of a user through restricting application permissions based on certain contexts.

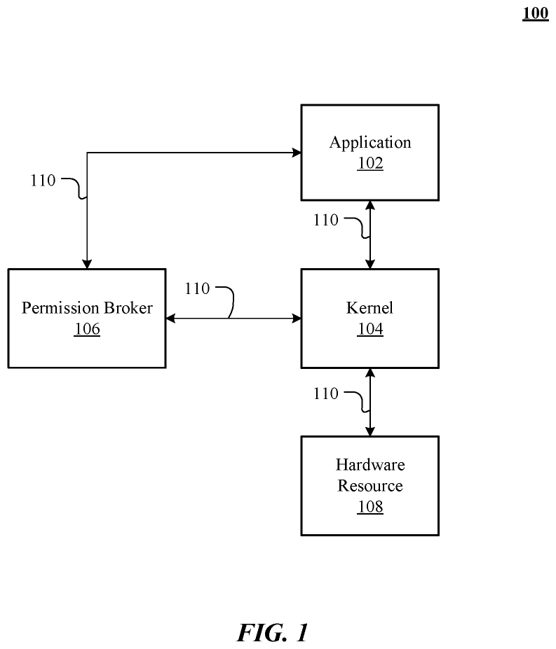

Referring to FIG. 1, an example operating system environment 100 is shown. The operating system environment 100 may be executed on a computing system. As an example and not by way of limitation, the computing system may be a virtual reality or augmented reality headset device. The operating system environment 100 may comprise an application 102, a kernel 104, a permission broker 106, and a hardware resource 108. In particular embodiments, each of the components may be connected through a link 110. In particular embodiments, the various components 102, 104, 106, 108 may communicate through system calls via the links 110. The links 110 may be embodied as other communication channels between components of an operating system environment. While only certain links 110 are shown, other links 110 connecting any of the components may be contemplated. In particular embodiments, links 110 may be added in response to establishing connections between components 102, 104, 106, 108. As an example and not by way of limitation, the kernel 104 may establish a connection between the application 102 and the hardware resource 108.

In particular embodiments, the application 102 may be any kind of application installed on a computing system. As an example and not by way of limitation, the application 102 may be a social media application, an online music application, etc. The application 102 may comprise one or more permission rules that defines a criterion for permitting the application 102 to access a hardware resource 108. The criterion may identify a logic predefined by the operating system and a condition for satisfying the logic. In particular embodiments, prior to installation of the application 102 on a computing system, one or more permission rules may be reviewed through a third-party to verify that the permission rules comply with established standards. These standards may be implemented to ensure the permission rules would not allow the application 102 to compromise the security or privacy of the user of the computing system. In particular embodiments, the permission rules may be installed with the application 102 on the computing system. The term “permission rules” may be used interchangeably with “permission settings.”

In particular embodiments, the kernel 104 may be a microkernel of an operating system environment 100. The kernel 104 may be configured to issue access tokens to applications requesting hardware resource access. The kernel 104 may check to determine whether an application 102 should be allowed access to a hardware resource 108 based on whether the context information satisfies contextual criterion associated with the permission rules. In particular embodiments, the kernel 104 may enable or deny access to the hardware resource 108 based on the determination. In particular embodiments, the kernel 104 may communicate with the permission broker 106 to determine whether the application 102 is allowed to access the hardware resource 108.

In particular embodiments, the permission broker 106 may be a service in a user space of an operating system environment 100. In particular embodiments, the permission broker 106 may record permission settings of various applications. The permission settings may define a condition that needs to be satisfied in order for an application to receive access to a hardware resource 108. As an example and not by way of limitation, the application 102 may be Instagram requesting access to a camera. The permission settings associated with Instagram may be the application 102 can only access the camera during the day in any location besides a user's home. These permission settings may also apply to other settings for an application in addition to access to hardware resources. As an example and not by way of limitation, the permission settings may only allow an application 102 to access certain websites. Although example permission settings are discussed, other permission settings may be contemplated. In particular embodiments, the permission broker 106 may store permission settings of installed applications. The permission broker 106 may access the permission settings of an application 102 to determine whether the application 102 is allowed access. To do so, the permission broker 106 may access context information associated with a contextual criterion of the permission settings. As an example and not by way of limitation, if the permission settings of an application 102 specifies that the application 102 is allowed access to a hardware resource 108 only at the user's home, then the permission broker 106 may communicate with a location service to retrieve location data and determine whether the permission settings are satisfied. In particular embodiments, the kernel 104 may conduct the determination of whether permission settings have been satisfied. In particular embodiments, the permission broker 106 may override permission settings associated with applications 102. As an example and not by way of limitation, the permission broker 106 may remove access to a hardware resource 108 or prevent an application 102 from performing an operation. As an example and not by way of limitation, if an application 102 has permission settings that specify the application 102 is allowed to access a camera any time during the day at any location, the permission broker 106 may have override the application's 102 access with a setting that prevents camera access at night.

In particular embodiments, the application 102 may initially send a request to the permission broker 106 for an access token for the hardware resource 108 via the link 110. As an example and not by way of limitation, the application 102 may need to access a hardware resource 108 (e.g., a camera). The application 102 may send a request for an access token for the hardware resource 108 to the permission broker 106. The access token may represent permission information data that indicates a capability to access a resource, perform an operation, and other capabilities within an operating system environment 100. The permission broker 106 may review the permission settings associated with the application 102 to determine whether the application 102 should be allowed to receive an access token for the hardware resource 108. The permission broker 106 may additionally determine whether context information satisfies a contextual criterion of the permission settings. As an example and not by way of limitation, if a location context is satisfied for the application 102 to receive an access token, such as if the computing system is located within a user's home location. In particular embodiments, the permission broker 106 may initially determine the application 102 has access to the hardware resource 108 without reviewing the context information. The permission broker 106 may send a request to the kernel 104 to issue an access token to the application 102 via the link 110. The kernel 104 may send an access token to the application 102 via the link 110. The application 102 may subsequently send a request to access the hardware resource 108 to the kernel 104 via the link 110 with the access token. The kernel 104 may send a request to the permission broker 106 to determine whether contextual criterion of the application's 102 permission settings are satisfied. In particular embodiments, the kernel 104 may perform the determination. After receiving a determination from the permission broker 106, the kernel 104 may allow or deny access to the hardware resource 108 for the application 102.

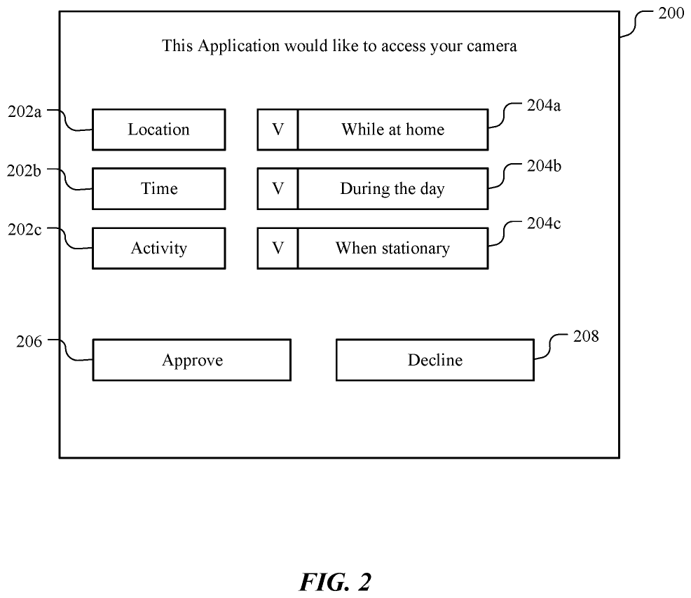

Referring to FIG. 2, an example permission request 200 is shown. In particular embodiments, when an application 102 is installed on a computing system, the application 102 may request permission for certain capabilities. In particular embodiments, certain capabilities may be approved or denied in the background without user intervention. The certain capabilities that may be approved or denied in the background may be determined to not compromise the user's privacy or security of the computing system. The user of a computing system may be presented the permission request 200 after installation of an application 102. The presentation of the permission request 200 may be in the form of a notification that appears on a display of the computing system of the user. The permission request 200 may be separate for different capabilities or the permission request 200 may combine similar capabilities. As an example and not by way of limitation, access to a website and access to a camera may both be restricted by similar contextual criterion. In particular embodiments, the permission broker 106 may generate the permission request 200 to request user approval for providing capabilities to an application 102. The permission request 200 may specify a capability that an application is requesting permission to access. As an example and not by way of limitation, the application 102 may be requesting permission to access the camera. The permission request 200 may comprise contextual criterion categories 202. Although only contextual criterion categories 202a-202c are shown, there may be other contextual criterion categories 202 not shown. In addition, there may be any combination of contextual criterion categories 202a-202c for a permission request 200. The permission broker 106 may identify the contextual criterion categories from the permission settings of the application 102. The permission broker 106 may identify for a particular capability (e.g., access to a camera) certain contextual criterion categories (e.g., location, time, activity). The permission request 200 may specify contextual criterion conditions 204a-204c that must be satisfied in order for the application 102 to have access to the capability (e.g., access to the camera). In particular embodiments, the user may adjust the permission request 200 by adding, removing, or manipulating the contextual criterion categories 202 and/or the contextual criterion conditions 204. As an example and not by way of limitation, if the user wishes to remove a restriction of using a camera while using the application 102, the user may remove the contextual criterion category 202, activity. As an example and not by way of limitation, the user may change the time contextual criterion category 202 to all day. In particular embodiments, the permission broker 106 may notify the user of security or privacy compromising changes.

In particular embodiments, the permission request 200 may comprise an approve interactive element 206 and a decline interactive element 208. The user may decide whether to approve the permission request 200 with the given contextual criterion. If the user decides to approve the permission request, the permission broker 106 may store the permission request 200 and associated the permission request 200 with the application 102. The permission broker 106 may also request the kernel 104 to issue an access token to the application for the particular capability. If the user decides to decline the permission request 200, the permission broker 106 may store the permission request 200 with a record to decline an application's 102 request for an access token or access to a resource. While the user may initially approve the permission request 200, the user may alter or remove the application's 102 access to a resource or capability.

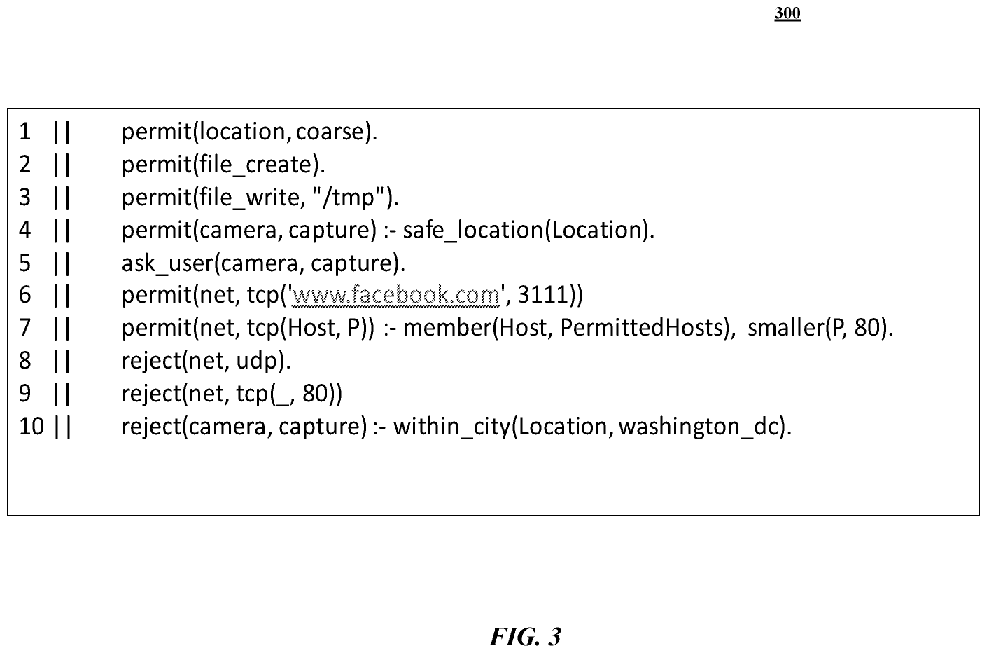

Referring to FIG. 3, an example list 300 of example permission settings is shown. As an example and not by way of limitation, the list 300 may represent various permission settings that may be installed with an application 102. While described as a permissions setting, the permission settings may represent programmable rules to be evaluated to allow an application access to a resource or a capability. The list 300 of permission settings may specify various capabilities available to the application 102. Each of the permission settings may also specify contexts that need to be satisfied to provide the application 102 permission to enable the capability. The contexts may be associated with one or more dynamic variables, such as location, time, and the like. The contexts may also be associated with logic that is embedded into the permission setting. As an example and not by way of limitation, the application 102 may be allowed to create files through the “permit(file_crite)” permission setting with no specified context. As another example and not by way of limitation, the application may be allowed to use the camera through the “permit(camera, capture):-safe_location(location)”, which specifies a context. As another example and not by way of limitation, permission settings, such as “reject(net, udp)” may indicate what capabilities to deny an application. Additionally, permission setting “ask_user(camera, capture)” may request user approval of application access through a permission request 200.

In particular embodiments, the permission settings may be updated after an application 102 has been installed on a computing system (e.g., through an application update). The various dynamic variables may be updated, added and/or removed over time.

In particular embodiments, the list 300 of permissions settings may specify overrides that the permission broker 106 has specified for permission settings for applications 102. In particular embodiments, the overrides may be specific for certain applications or generalized to all applications installed on the computing device. In particular embodiments, the overrides may apply to only applications that request a particular capability. As an example and not by way of limitation, the permission broker 106 may restrict access to a camera for all applications. In particular embodiments, the user may override any permission settings.

In particular embodiments, the language of the permission settings may comprise a rule that may be programmable by an application. The language of the permission settings may comprise dynamic variables associated with the rule. These rules may be dynamically reevaluated when conditions change. As an example and not by way of limitation, when one of the dynamic variables change by a threshold amount, such as for a location variable, when the computing system has moved more than 20 meters. The language of the permission settings may standardize the rules implemented by the permissions settings. The language of permission settings may comprise one or more of permits, rejects, and ask users. The language of permission settings may allow for combinations of various dynamic variables to implement complex logic. As an example and not by way of limitation, “permit(camera, capture):-safe_location(Location), day_time(Time)” may allow an application to take pictures in safe locations only during the day. In particular embodiments, the use of the permits and rejects may enable and deny access to resources and capabilities if certain conditions are met. These conditions are based on the dynamic variables. As an example and not by way of limitation, while a “permit(camera, capture):-day_time(Time)” may allow for an application to access a hardware resource (e.g., a camera) during the day, a “reject(camera, capture):-day_time(Time)” would deny the application from accessing a hardware resource during the day. The dynamic variables may be evaluated and reevaluated when it is determined that a threshold change of the corresponding variable has occurred. As an example and not by way of limitation, if the variable is based on time, then after a period of time (e.g., 1 hour) the permission setting may be reevaluated to determine whether the application still has access to the corresponding hardware resource.

In particular embodiments, a computing system may automatically generate descriptions of an application's capabilities based on the permission settings of the application. As an example and not by way of limitation, if the application has a list of permission settings: “permit(file_create)”, “permit(location, coarse)”, and “permit(camera, capture):-safe_Location(location)”, then the computing system may generate the descriptions: “Can create any file”, “Can get coarse GPS location”, and “Can take pictures in safe locations”. The computing system may analyze the permission settings of the application in order to generate the descriptions based on the rules and dynamic variables of the respective permission setting. This allows for generation of a description that is standardized and reduces errors in descriptions. Through the analysis of the specific rule matched with any dynamic rules in the permission setting, the computing system may be able to generate an accurate description of what the permission setting allows for an application to do. The description may be generated and presented to a user. The presentation of an application's capabilities may allow for the user to properly approve or deny any permission requests the application may send. The presentation of the application's capabilities may also allow the user to override any permission settings accordingly to restrict the application's access to certain resources or capabilities.

In particular embodiments, a computing system may test permission settings associated with an application. As an example and not by way of limitation, a computing system may determine whether an application has access to certain capabilities. In particular embodiments, the computing system may have a test procedure where it determines if an application has access to a set of permission settings. The set of permission settings may be associated with particular capabilities that may compromise a user's privacy or device security if the application is enabled to the respective permission settings. The test may quickly identify whether the application has access to these specific permission settings and may enable the user to revoke access to the capabilities associated with the respective permission settings.

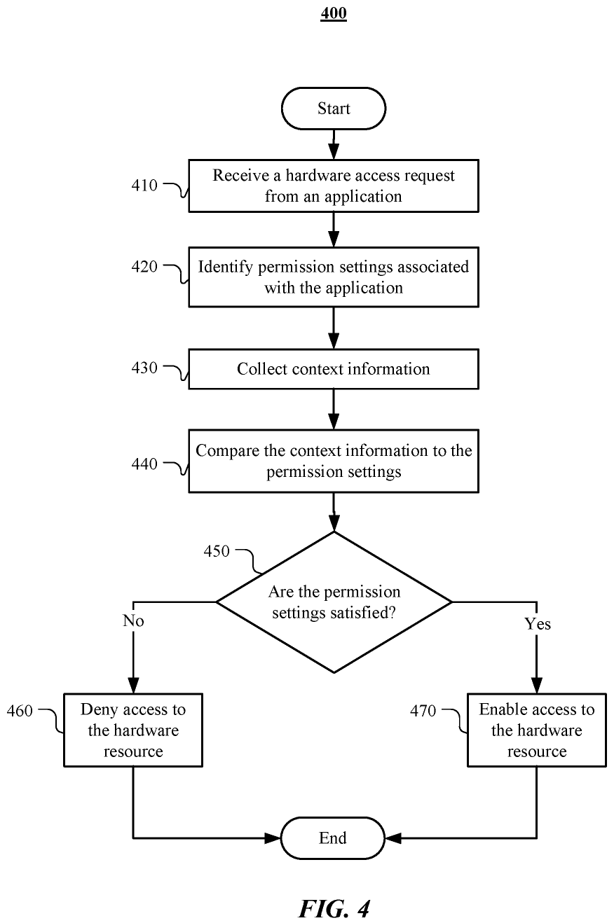

Referring to FIG. 4, an example diagram flow 400 of handling a hardware access request is shown. In particular embodiments, the flow 400 may start at step 410, where a kernel may receive a hardware access request from an application. As an example and not by way of limitation, an application may send a request to access a camera to the kernel. At step 420, the kernel may identify permission settings associated with the application. As an example and not by way of limitation, the kernel may access stored permission settings or communicate with a permission broker to identify permission settings associated with the application. At step 430, the kernel may collect context information associated with the contextual criterion associated with the permission settings. As an example and not by way of limitation, the kernel may access GPS location. At step 440, the kernel may compare the context information to the permission settings. At step 450, the kernel may determine whether the permission settings have been satisfied. As an example and not by way of limitation, the kernel may determine whether the context information indicates the device is within a certain distance from a specified location associated with the permission settings. If the kernel determines the permission settings have not been satisfied, then the flow 400 may proceed to step 460, where the kernel denies access to the hardware resource. However, if the kernel determines the permission settings have been satisfied, then the flow 400 may proceed to step 470, where the kernel enables access to the hardware resource. Although, the flow 400 is described as the kernel performing the steps, the flow 400 may be performed by the permission broker or a combination of the permission broker and the kernel.

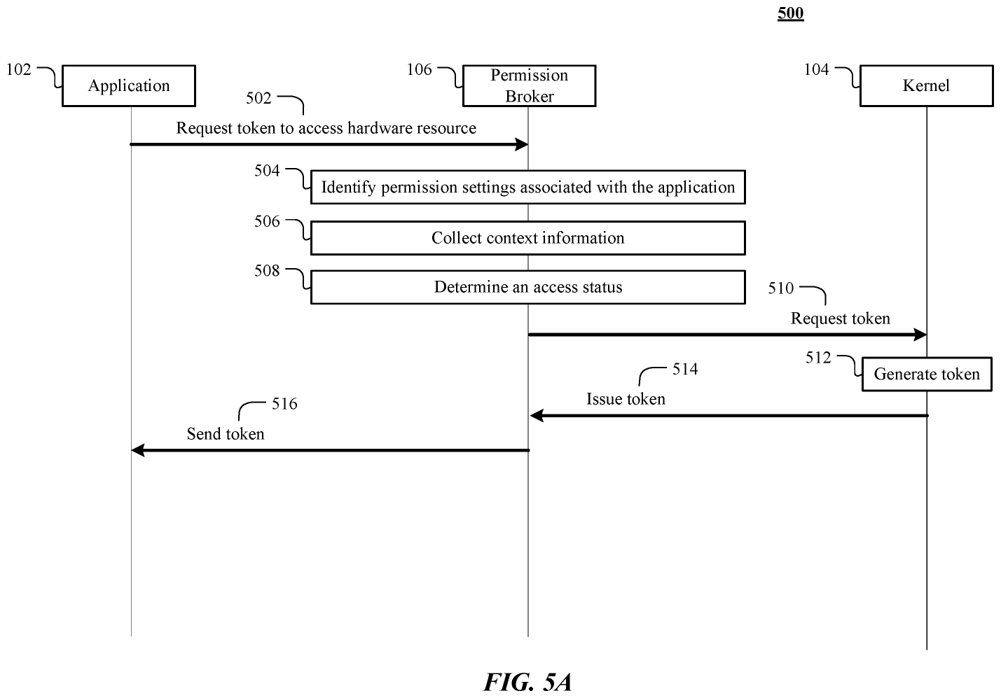

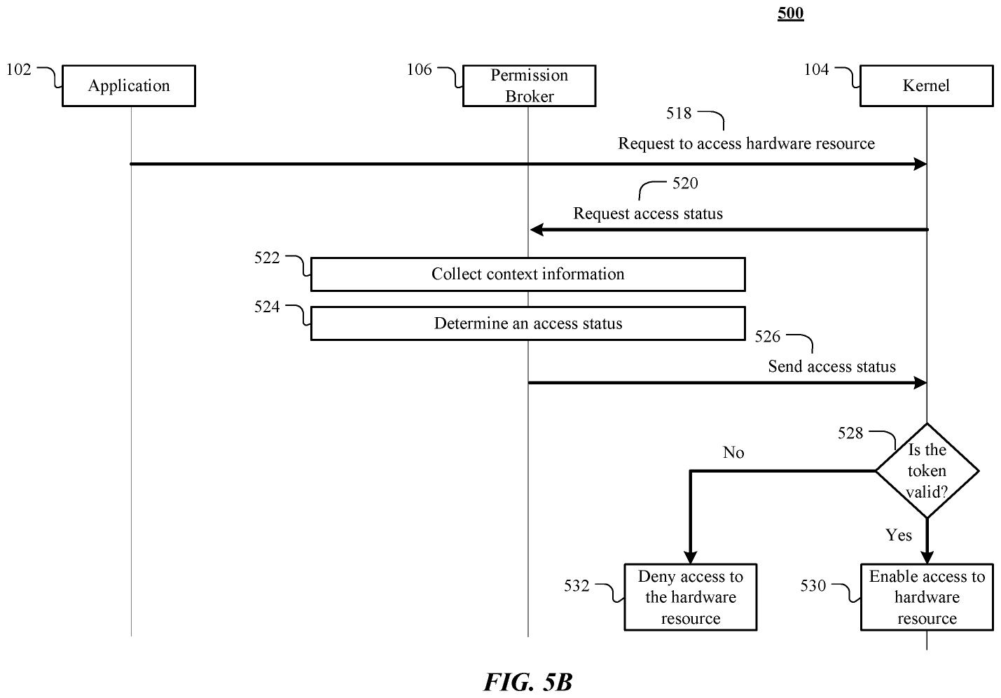

Referring to FIGS. 5A-5B, example diagram flows of requesting hardware access within an operating system environment 500 is shown. In particular embodiments, the operating system environment 500 may comprise an application 102, a kernel 104, and a permission broker 106. Referring to FIG. 5A, initially an application 102 may send a request for a token to access a hardware resource to the permission broker 106 in step 502. While the request specifies a token for access to a hardware resource, the token may be to enable another capability. After receiving the request from the application 102, the permission broker 106 may identify permission settings associated with the application 102 in step 504. To do so, the permission broker 106 may access the permission settings installed with the application 102. The permission broker 106 may also record the permission settings associated with the application 102. At step 506, the permission broker 106 may collect context information. The permission broker 106 may communicate to various services, such as a location service to collect context information. The permission broker 106 may collect context information specified by the permission settings. As an example and not by way of limitation, the permission settings associated with the application may specify a contextual criterion, such as location, and the permission broker 106 may collect context information associated with location information. At step 508, the permission broker 106 may determine an access status based on a comparison of the collected context information compared to the permission settings. After the permission broker 106 determines the application 102 has been granted access status to the requested hardware resource, the permission broker 106 may send a request for a token to the kernel 104 for the application 102. The kernel 104 may generate an access token at step 512. At step 514, the kernel 104 may issue the token to the application 102 by sending the token to the permission broker 106 to send to the application 102 at step 516.

Referring to FIG. 5B, after the application 102 has received an access token, at step 518, the application 102 may send a request to access the hardware resource associated with the access token. The request may also comprise the access token. The kernel 104 may request an access status 520 from the permission broker 106. The request for the access status may comprise the access token or specify an application and a permission setting. At step 522, the permission broker 106 may collect the current context information associated with the permission settings associated with the application. The permission broker 106 may use the access token to identify the appropriate permission setting associated with the application 102. The permission broker 106 may collect context information similarly to step 506. At step 524, the permission broker 106 may determine an access status similarly to step 508. After determining the access status of the application 102, the permission broker 106 may send the access status to the kernel 104 in step 526. At step 528, the kernel 104 may determine whether the access token is valid. In particular embodiments, the kernel 104 may perform steps 522 and 524 in order to determine whether the access token is valid in step 528. If the access token has been determined to be valid, then the kernel 104 may enable access to the hardware resource to the application 102 at step 530. However, if the access token has been determined to not be valid, then the kernel 104 may deny access to the hardware resource to the application 102 at step 532.

In particular embodiments, the permission broker 106 or the kernel 104 may subscribe to services to receive context information corresponding to permission settings associated with the application 102. As an example and not by way of limitation, the permission broker may be subscribed to a location service to received location information. Therefore, if a permission setting specifies that an application 102 has access to a camera only within a user's home, then upon the location service detecting a change in location information and sending the update to the permission broker 106, the permission broker 106 may revoke the application's 102 access to the camera. In particular embodiments, if the permission broker 106 detects the user is currently using an application 102 feature that utilizes the hardware resource in question, then the permission broker 106 may notify the user. The notification to the user may also include a request to either change the permission settings associated with the application 102 or grant a one-time use of the hardware resource outside the specified contexts to allow the user to finish using the application 102. As an example and not by way of limitation, if a user was taking a video and the time has sufficiently elapsed where the time is outside a contextual criterion (e.g., only during the day) specified by the application's 102 permission settings, then the user can prolong the application's use of a camera to complete the video.

In particular embodiments, the permission broker 106 may detect an event that affects permission settings of the application 102. The event can be a change in a dynamic variable associated with a permission setting of the application 102, an override, or any kind of event that affects the permissions settings of the application 102. In particular embodiments, the permission broker 106 may determine an override has been implemented to restrict or allow access to a resource. This may be an override that has been implemented after the permission broker 106 initially determines an access status of an application 102 in either steps 508 or 524. As an example and not by way of limitation, the user may issue a revoke command of camera access to applications during night time. The permission broker 106 may receive the command and reevaluate the access status of the application 102. After the permission broker 106 reevaluates an access status of an application 102, the permission broker 106 may send an update to the kernel 104, which may subsequently revoke access of an application 102 to a hardware resource or a capability.

In particular embodiments, the user may implement an override to permission settings that apply to all applications 102 installed on the computing system of the user. The user may access a user interface similar to the permission request 200 where the user may select one or more hardware resources to generate an override. The user may proceed to adjust one or more contextual criterion categories and contextual criterion conditions associated with the categories. As an example and not by way of limitation, the user may use the user interface to input an override to restrict camera access to all applications at night time. In particular embodiments, one or more applications 102 may send a notification that an override may affect the application's 102 performance. The user may respond to notifications by continuing to restrict access to a specified resource or capability or allow access to certain applications.

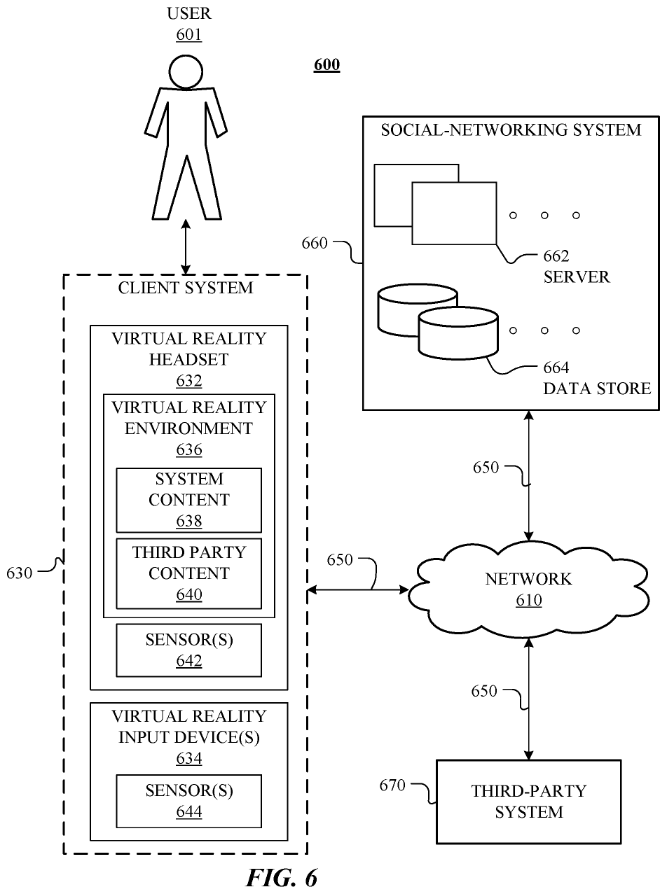

FIG. 6 illustrates an example network environment 600 associated with a virtual reality system. Network environment 600 includes a user 601 interacting with a client system 630, a social-networking system 660, and a third-party system 670 connected to each other by a network 610. Although FIG. 6 illustrates a particular arrangement of a user 601, a client system 630, a social-networking system 660, a third-party system 670, and a network 610, this disclosure contemplates any suitable arrangement of a user 601, a client system 630, a social-networking system 660, a third-party system 670, and a network 610. As an example and not by way of limitation, two or more of a user 601, a client system 630, a social-networking system 660, and a third-party system 670 may be connected to each other directly, bypassing a network 610. As another example, two or more of a client system 630, a social-networking system 660, and a third-party system 670 may be physically or logically co-located with each other in whole or in part. Moreover, although FIG. 6 illustrates a particular number of users 601, client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple users 601, client systems 630, social-networking systems 660, third-party systems 670, and networks 610.

This disclosure contemplates any suitable network 610. As an example and not by way of limitation, one or more portions of a network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 610 may include one or more networks 610.

Links 650 may connect a client system 630, a social-networking system 660, and a third-party system 670 to a communication network 610 or to each other. This disclosure contemplates any suitable links 650. In particular embodiments, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 need not necessarily be the same throughout a network environment 600. One or more first links 650 may differ in one or more respects from one or more second links 650.

In particular embodiments, a client system 630 may be an electronic device including hardware, software, or embedded logic components or a combination of two or more such components and capable of carrying out the appropriate functionalities implemented or supported by a client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, virtual reality headset and controllers, other suitable electronic device, or any suitable combination thereof. This disclosure contemplates any suitable client systems 630. A client system 630 may enable a network user at a client system 630 to access a network 610. A client system 630 may enable its user to communicate with other users at other client systems 630. A client system 630 may generate a virtual reality environment for a user to interact with content.

In particular embodiments, a client system 630 may include a virtual reality (or augmented reality) headset 632, such as OCULUS RIFT and the like, and virtual reality input device(s) 634, such as a virtual reality controller. A user at a client system 630 may wear the virtual reality headset 632 and use the virtual reality input device(s) to interact with a virtual reality environment 636 generated by the virtual reality headset 632. Although not shown, a client system 630 may also include a separate processing computer and/or any other component of a virtual reality system. A virtual reality headset 632 may generate a virtual reality environment 636, which may include system content 638 (including but not limited to the operating system), such as software or firmware updates and also include third-party content 640, such as content from applications or dynamically downloaded from the Internet (e.g., web page content). A virtual reality headset 632 may include sensor(s) 642, such as accelerometers, gyroscopes, magnetometers to generate sensor data that tracks the location of the headset device 632. The headset 632 may also include eye trackers for tracking the position of the user's eyes or their viewing directions. The client system may use data from the sensor(s) 642 to determine velocity, orientation, and gravitation forces with respect to the headset. Virtual reality input device(s) 634 may include sensor(s) 644, such as accelerometers, gyroscopes, magnetometers, and touch sensors to generate sensor data that tracks the location of the input device 634 and the positions of the user's fingers. The client system 630 may make use of outside-in tracking, in which a tracking camera (not shown) is placed external to the virtual reality headset 632 and within the line of sight of the virtual reality headset 632. In outside-in tracking, the tracking camera may track the location of the virtual reality headset 632 (e.g., by tracking one or more infrared LED markers on the virtual reality headset 632). Alternatively or additionally, the client system 630 may make use of inside-out tracking, in which a tracking camera (not shown) may be placed on or within the virtual reality headset 632 itself. In inside-out tracking, the tracking camera may capture images around it in the real world and may use the changing perspectives of the real world to determine its own position in space.

Third-party content 640 may include a web browser and may have one or more add-ons, plug-ins, or other extensions. A user at a client system 630 may enter a Uniform Resource Locator (URL) or other address directing a web browser to a particular server (such as server 662, or a server associated with a third-party system 670), and the web browser may generate a Hyper Text Transfer Protocol (HTTP) request and communicate the HTTP request to server. The server may accept the HTTP request and communicate to a client system 630 one or more Hyper Text Markup Language (HTML) files responsive to the HTTP request. The client system 630 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts, combinations of markup language and scripts, and the like. Herein, reference to a web interface encompasses one or more corresponding source files (which a browser may use to render the web interface) and vice versa, where appropriate.

In particular embodiments, the social-networking system 660 may be a network-addressable computing system that can host an online social network. The social-networking system 660 may generate, store, receive, and send social-networking data, such as, for example, user-profile data, concept-profile data, social-graph information, or other suitable data related to the online social network. The social-networking system 660 may be accessed by the other components of network environment 600 either directly or via a network 610. As an example and not by way of limitation, a client system 630 may access the social-networking system 660 using a web browser of a third-party content 640, or a native application associated with the social-networking system 660 (e.g., a mobile social-networking application, a messaging application, another suitable application, or any combination thereof) either directly or via a network 610. In particular embodiments, the social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 662 may include hardware, software, or embedded logic components or a combination of two or more such components for carrying out the appropriate functionalities implemented or supported by server 662. In particular embodiments, the social-networking system 660 may include one or more data stores 664. Data stores 664 may be used to store various types of information. In particular embodiments, the information stored in data stores 664 may be organized according to specific data structures. In particular embodiments, each data store 664 may be a relational, columnar, correlation, or other suitable database. Although this disclosure describes or illustrates particular types of databases, this disclosure contemplates any suitable types of databases. Particular embodiments may provide interfaces that enable a client system 630, a social-networking system 660, or a third-party system 670 to manage, retrieve, modify, add, or delete, the information stored in data store 664.

In particular embodiments, the social-networking system 660 may store one or more social graphs in one or more data stores 664. In particular embodiments, a social graph may include multiple nodes—which may include multiple user nodes (each corresponding to a particular user) or multiple concept nodes (each corresponding to a particular concept)—and multiple edges connecting the nodes. The social-networking system 660 may provide users of the online social network the ability to communicate and interact with other users. In particular embodiments, users may join the online social network via the social-networking system 660 and then add connections (e.g., relationships) to a number of other users of the social-networking system 660 whom they want to be connected to. Herein, the term “friend” may refer to any other user of the social-networking system 660 with whom a user has formed a connection, association, or relationship via the social-networking system 660.

In particular embodiments, the social-networking system 660 may provide users with the ability to take actions on various types of items or objects, supported by the social-networking system 660. As an example and not by way of limitation, the items and objects may include groups or social networks to which users of the social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 660 or by an external system of a third-party system 670, which is separate from the social-networking system 660 and coupled to the social-networking system 660 via a network 610.

In particular embodiments, the social-networking system 660 may be capable of linking a variety of entities. As an example and not by way of limitation, the social-networking system 660 may enable users to interact with each other as well as receive content from third-party systems 670 or other entities, or to allow users to interact with these entities through an application programming interfaces (API) or other communication channels.

In particular embodiments, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating the social-networking system 660. In particular embodiments, however, the social-networking system 660 and third-party systems 670 may operate in conjunction with each other to provide social-networking services to users of the social-networking system 660 or third-party systems 670. In this sense, the social-networking system 660 may provide a platform, or backbone, which other systems, such as third-party systems 670, may use to provide social-networking services and functionality to users across the Internet.

In particular embodiments, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 660 also includes user-generated content objects, which may enhance a user's interactions with the social-networking system 660. User-generated content may include anything a user can add, upload, send, or “post” to the social-networking system 660. As an example and not by way of limitation, a user communicates posts to the social-networking system 660 from a client system 630. Posts may include data such as status updates or other textual data, location information, photos, videos, links, music or other similar data or media. Content may also be added to the social-networking system 660 by a third-party through a “communication channel,” such as a newsfeed or stream.

In particular embodiments, the social-networking system 660 may include a variety of servers, sub-systems, programs, modules, logs, and data stores. In particular embodiments, the social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 660 may also include suitable components such as network interfaces, security mechanisms, load balancers, failover servers, management-and-network-operations consoles, other suitable components, or any suitable combination thereof. In particular embodiments, the social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 660 to one or more client systems 630 or one or more third-party systems 670 via a network 610. The web server may include a mail server or other messaging functionality for receiving and routing messages between the social-networking system 660 and one or more client systems 630. An API-request server may allow a third-party system 670 to access information from the social-networking system 660 by calling one or more APIs. An action logger may be used to receive communications from a web server about a user's actions on or off the social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from a client system 630 responsive to a request received from a client system 630. Authorization servers may be used to enforce one or more privacy settings of the users of the social-networking system 660. A privacy setting of a user determines how particular information associated with a user can be shared. The authorization server may allow users to opt in to or opt out of having their actions logged by the social-networking system 660 or shared with other systems (e.g., a third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

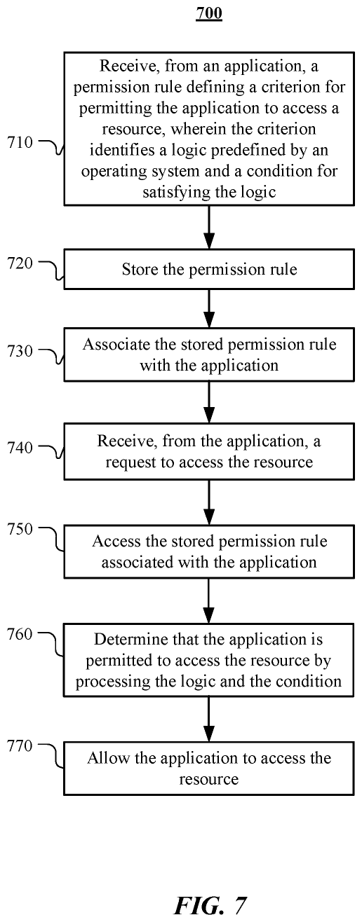

FIG. 7 illustrates an example method 700 for handling a permission rule associated with an application. The method may begin at step 710, where a kernel of an operating system executing on a computing system (e.g., augmented reality system or virtual reality system) may receive, from an application, a permission rule defining a criterion for permitting the application to access a resource. In particular embodiments, the criterion may identify a logic predefined by an operating system and a condition for satisfying the logic. At step 720, the kernel may store the permission rule. At step 730, the kernel may associate the stored permission rule with the application. At step 740, the kernel may receive, from the application, a request to access the resource. At step 750, the kernel may access the stored permission rule associated with the application. At step 760, the kernel may determine that the application is permitted to access the resource by processing the logic and the condition. At step 770, the kernel may allow the application to access the resource. In particular embodiments, while the kernel is described performing the steps above, the permission broker may perform the steps by itself or in combination with the kernel. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for handling a permission rule associated with an application, including the particular steps of the method of FIG. 7, this disclosure contemplates any suitable method of handling a permission rule associated with an application, including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

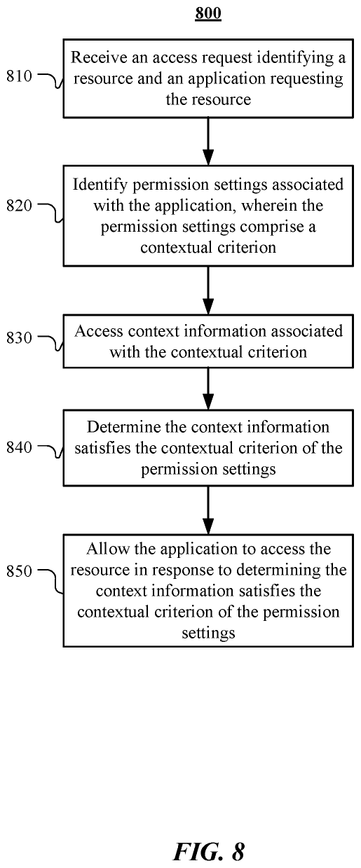

FIG. 8 illustrates an example method 800 for handling a hardware access request from an application. The method may begin at step 810, where a kernel of an operating system executing on a computing system (e.g., augmented reality system or virtual reality system) may receive an access request identifying a resource and an application requesting the resource. At step 820, the kernel may identify permission settings associated with the application. In particular embodiments, the permission settings may comprise a contextual criterion. At step 830, the kernel may access context information associated with the contextual criterion. At step 840, the kernel may determine the context information satisfies the contextual criterion of the permission settings. At step 850, the kernel may allow the application to access the resource in response to determining the context information satisfies the contextual criterion of the permission settings. In particular embodiments, while the kernel is described performing the steps above, the permission broker may perform the steps by itself or in combination with the kernel. Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for handling a hardware access request from an application, including the particular steps of the method of FIG. 8, this disclosure contemplates any suitable method of handling a hardware access request from an application, including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

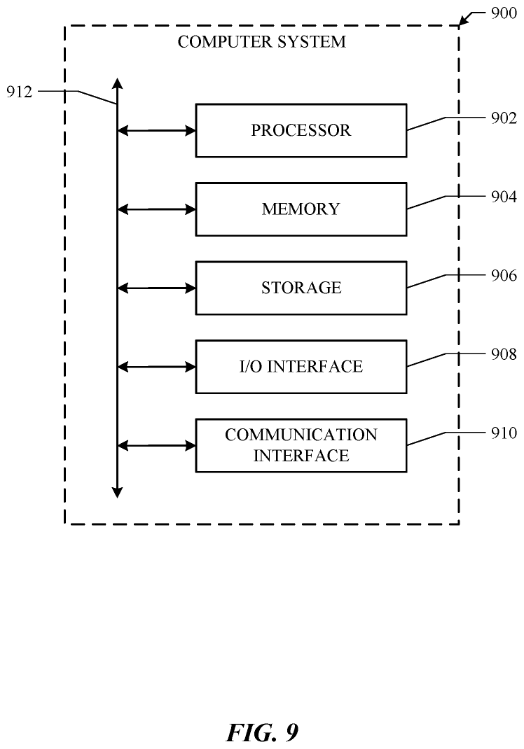

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An access control method, comprising:
receiving, from an application, a permission rule defining a criterion for permitting the application to access a resource, wherein the criterion identifies a logic predefined by an operating system and a condition for satisfying the logic;
storing the permission rule;
associating the stored permission rule with the application;
receiving, from the application, a request to access the resource;
accessing the stored permission rule associated with the application;
determining that the application is permitted to access the resource by processing the logic and the condition; and
allowing the application to access the resource.

2. The method of claim 1, wherein:
the condition for satisfying the logic comprises a reference to mutable data; and
the reference is predefined by the operating system.

3. The method of claim 2, further comprising:
accessing current data associated with the reference,
wherein the determination that the application is permitted to access the resource is further determined by processing the current data.

4. The method of claim 1, wherein:
the operating system comprises a microkernel and a permission service; and
the determination that the application is permitted to access the resource is performed by the permission service.

5. The method of claim 4, further comprising:
associating, by the microkernel, a token with the determination that the application is permitted to access the resource;
receiving, by the microkernel, the token from the application; and
determining that the token received from the application is associated with the determination that the application is permitted to access the resource,
wherein the allowing the application to access the resource is performed by the microkernel based on the token.

6. The method of claim 5, further comprising:
generating, by the microkernel, the token;
sending, by the microkernel, the generated token to the permission service; and
sending, by the permission service, the token to the application.

7. The method of claim 5, further comprising:
determining, by the permission service, that the application is prohibited from accessing the resource by processing the logic and the condition;
sending, by the permission service, an update request to the microkernel requesting the token to be associated with the determination that the application is prohibited from accessing the resource;
receiving, by the microkernel, the token from the application after the permission service sent the update request;
determining, by the microkernel, that the token received from the application after the permission service sent the update request is associated with the determination that the application is prohibited from accessing the resource; and
denying the application to access the resource.

8. A device, comprising:
one or more resources;
a memory operable to store:
one or more applications; and
permission rules defining a criterion for permitting an application to access a resource, wherein the criterion identifies a logic predefined by an operating system and a condition for satisfying the logic; and
the operating system executed by a processor operably coupled to the memory, configured to:
receive, from an application, a permission rule;
store the permission rule;
associate the stored permission rule with the application;
receive, from the application, a request to access the resource;
access the stored permission rule associated with the application;
determine that the application is permitted to access the resource by processing the logic and the condition; and
allow the application to access the resource.

9. The device of claim 8, wherein:
the condition for satisfying the logic comprises a reference to mutable data; and
the reference is predefined by the operating system.

10. The device of claim 9, wherein the operating system is further configured to:
access current data associated with the reference,
wherein the determination that the application is permitted to access the resource is further determined by processing the current data.

11. The device of claim 8, wherein:
the operating system comprises a microkernel and a permission service; and
the determination that the application is permitted to access the resource is performed by the permission service.

12. The device of claim 11, wherein the microkernel is configured to:
associate a token with the determination that the application is permitted to access the resource;
receive the token from the application; and
determine that the token received from the application is associated with the determination that the application is permitted to access the resource,
wherein the allowing the application to access the resource is performed by the microkernel based on the token.

13. The device of claim 12, wherein:
the microkernel is configured to:
generate the token;
send the generated token to the permission service; and
the permission service is configured to:
send the token to the application.

14. The device of claim 12, wherein:
the permission service is configured to:
determine that the application is prohibited from accessing the resource by processing the logic and the condition;
send an update request to the microkernel requesting the token to be associated with the determination that the application is prohibited from accessing the resource;
receive the token from the application after the permission service sent the update request; and
the microkernel is configured to:
determine that the token received from the application after the permission service sent the update request is associated with the determination that the application is prohibited from accessing the resource; and
deny the application to access the resource.

15. A computer program comprising executable instructions stored in a non-transitory computer readable medium that when executed by a processor causes the processor to:
receive, from an application, a permission rule defining a criterion for permitting the application to access a resource, wherein the criterion identifies a logic predefined by the operating system and a condition for satisfying the logic;
store the permission rule;
associate the stored permission rule with the application;
receive, from the application, a request to access the resource;
access the stored permission rule associated with the application;
determine that the application is permitted to access the resource by processing the logic and the condition; and
allow the application to access the resource.

16. The computer program of claim 15, wherein:
the condition for satisfying the logic comprises a reference to mutable data; and
the reference is predefined by the operating system.

17. The computer program of claim 16, further comprising instructions that when executed by the processor causes the processor to:
access current data associated with the reference,
wherein the determination that the application is permitted to access the resource is further determined by processing the current data.

18. The computer program of claim 15, further comprising instructions that when executed by the processor causes the processor to:
implement a microkernel and a permission service; and
the determination that the application is permitted to access the resource is performed by the permission service.

19. The computer program of claim 18, further comprising instructions that when executed by the processor causes the processor to:
associate, using the microkernel, a token with the determination that the application is permitted to access the resource;
receive, using the microkernel, the token from the application; and
determine that the token received from the application is associated with the determination that the application is permitted to access the resource;
wherein the allowing the application to access the resource is performed by the microkernel based on the token.

20. The computer program of claim 19, further comprising instructions that when executed by the processor causes the processor to:
determine, using the permission service, that the application is prohibited from accessing the resource by processing the logic and the condition;
send, using the permission service, an update request to the microkernel requesting the token to be associated with the determination that the application is prohibited from accessing the resource;
receive, using the microkernel, the token from the application after the permission service sent the update request;
determine, using the microkernel, that the token received from the application after the permission service sent the update request is associated with the determination that the application is prohibited from accessing the resource; and
deny the application to access the resource.
